(19) United States
(12) Patent Application Publication
(10) Pub. No.: US 2024/0421475 A1
(43) Pub. Date: Dec. 19, 2024

(54) ANTENNA TUNING DEVICE

(71) Applicant: Rohde & Schwarz GmbH & Co. KG, Muenchen (DE)

(72) Inventors: Martin LASINGER, Muenchen (DE); Johannes CHRISTL, Muenchen (DE)

(21) Appl. No.: 18/654,368

(22) Filed: May 3, 2024

(30) Foreign Application Priority Data
Jun. 14, 2023 (EP) 23 179 331.6

(51) Int. Cl. H01Q 3/12; H01Q 13/18

(52) U.S. Cl. CPC H01Q 3/12; H01Q 13/18

(57) ABSTRACT

The invention relates to an antenna tuning device for tuning a frequency. The antenna tuning device comprises at least one actuator and a movable rod. At least one stop washer and a piston are connected to the rod. The rod is moveable between a first end position and a second end position. The piston is located in a cavity filled with a fluid such that a movement of the piston compresses the fluid inside the cavity, thereby dampening the movement of the rod prior to reaching the respective end position.

### FIELD OF THE DISCLOSURE

Embodiments of the present disclosure relate to an antenna tuning device for tuning a frequency, for example a transmission frequency.

### BACKGROUND

In the state of the art, antenna tuning devices, also called antenna matching devices, are known for use in matching an antenna to a respective frequency, particularly a transmission frequency. For this purpose, a suitable combination of coils from a set of different coils may be electrically connected by an actuator that establishes the respective electrical connection of the coils. The electrical connection is established when high voltages are applied such that large air gaps and switching distances to be bridged are required in order to avoid sparkover.

The respective combination of coils is automatically determined by the antenna tuning device, particularly in an iterative manner. Hence, frequent and fast switching is performed until the optimized combination of coils is found that is to be used for the respective frequency. This frequent switching requires maximum actuation forces in order to obtain short switching times, as the switching times add up.

However, the short switching times generate high accelerations, especially at the end of the movement. The movement however has to be stopped in a defined manner. Accordingly, a stop washer is required at which a movable component is stopped. The exact end position of the movable component is important because this defines the exact position of the high-voltage contact that establishes the electrical connection.

The required high accelerations to obtain the short switching times result in a large impact on the stop washer and thus in very high forces and consequently mechanical stresses. Stop washers made of metal can withstand those loads, but they generate unacceptably high noise levels. To avoid these high noise levels, stop washers made of plastic can be used. However, these plastic stop washers may become brittle and break/fatigue before the planned service life, especially at low temperatures.

Accordingly, there is a need for extending the useful lifetime of an antenna tuning device even though it is operated at low temperatures.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

The present disclosure provides examples of an antenna tuning device for tuning a frequency. In an embodiment, the antenna tuning device comprises at least one actuator and a movable rod. At least one stop washer and a piston are connected to the rod. The rod is movable between a first end position and a second end position. The piston is located in a cavity filled with a fluid such that a movement of the piston compresses the fluid inside the cavity, thereby dampening the movement of the rod prior to reaching the respective end position.

The main idea is to provide an additional dampening mechanism, namely a fluid dampening mechanism, which is established by the cavity filled with the fluid in which the piston is movably located. During the switching mechanism initiated by the at least one actuator, the piston is moved by the rod with which the piston is connected, thereby compressing the fluid within the cavity. This causes a deceleration of the piston and, thus, the rod shortly before the respective end position is reached. Consequently, the impact on the at least one stop washer can be reduced significantly, as the velocity of the rod is reduced before the stop washer gets contacted in the respective end position. Therefore, wear of the stop washer can be reduced, for example at low temperatures, such that the usable lifetime of the stop washer can be extended, for example the usable lifetime of the entire antenna tuning device.

In an embodiment, the switching times are not prolonged significantly by the additional fluid dampening mechanism, namely the cavity filled with the fluid and the piston movably located within the cavity. Therefore, it is still possible to perform the automatic switching procedure in an iterative manner in order to obtain the optimized combination of coils for tuning the frequency.

In an embodiment, the fluid dampening mechanism is not subjected to wear during the dampening since no mechanical contact of any components of the fluid dampening mechanism takes place. In other words, the fluid dampening mechanism provides a contactless dampening. Therefore, no restrictions with regard to the usable lifetime of the antenna tuning device take place due to the additional fluid dampening mechanism.

In an embodiment, the fluid dampening mechanism only protects the mechanical impact of the at least one stop washer.

In an embodiment, the at least one stop washer may be a separately formed component that is connected to the rod, but connected to the rod in order to ensure that the at least one stop washer is moved simultaneously with the rod.

In an embodiment, the piston may also be formed separately with respect to the rod, but connected to the rod in order to ensure that the piston is moved simultaneously with the rod. Alternatively, the piston and the rod are made by one piece.

According to an embodiment, the cavity is closed. Therefore, the fluid within the cavity may be encompassed by a (single) case such that the fluid cannot escape from the space enclosed by the case, namely the cavity. In other words, the entire fluid dampening mechanism is a closed mechanism, as no fluid exchange with the environment takes place.

According to an alternative embodiment, the cavity is at least partly opened. For instance, openings may be provided in a case such that the fluid, for instance air, may be exchanged with an environment. In other words, the piston may press the fluid at least partly out of the cavity. Moreover, two cup-shaped cases may be provided that are separately formed, wherein these cup-shaped cases are located opposite to each other via their open sides.

According to another aspect, the piston, for example, divides a space of the cavity into two parts. As indicated above, the cavity may be enclosed by a case, for instance a metal case. The case delimits a space in which the piston is movably located, which corresponds to the cavity. The piston is moved between two positions within the cavity, which are associated with the end positions of the rod.

Depending on the respective movement, the space is divided into two parts that may be sized differently depending on the position of the piston. In the respective end positions of the rod, the piston may be located close to a side wall of the case. Typically, a small gap is provided between a surface of the piston facing towards the side wall of the case, wherein the surface and the respective side wall are perpendicularly orientated with respect to a movement direction of the rod and/or the piston.

For instance, the piston may comprise at least one opening that provides a fluid passage between both parts. As mentioned above, the piston may divide the space into two parts that however are fluidly connected with each other via the at least one opening provided in the piston such that the fluid can flow along the fluid passage from a first part to the second part, which depends on the movement of the piston within the cavity.

According to an embodiment, the size of the at least one opening is adaptable. The resistance of the piston can be set, as the amount of fluid enabled to flow along the fluid passage can be set accordingly.

Alternatively or additionally, the dimension of the cavity is bigger than the dimension of the piston such that a gap is provided. The gap may be provided between an outer surface of the piston and an inner surface of the case delimiting the cavity. The gap provides a passage for the fluid along which the fluid can flow when it gets compressed by the piston during an actuation.

In an embodiment, the gap may be provided alternatively to the at least one opening in the piston. However, the opening in the piston as well as the gap may be provided simultaneously.

According to a further aspect, the at least one actuator, for example, is a solenoid. The solenoid, also called an electromagnet, is energized in order to generate a magnetic field that interacts with the rod directly or indirectly, e.g. with a magnetizable material.

For instance, a first actuator and a second actuator are provided, wherein an actuated member is located between the first actuator and the second actuator. The actuated member is connected to the rod. Alternatively, the actuated member and the rod are made by one piece. The first and second actuators may be solenoids that can be energized independently of each other. Hence, the actuated member can be made of a magnetizable material such that it gets actuated by a magnetic force generated by the actuators, for example the solenoids. Depending on the actuation of one of the actuators, the actuated member is moved towards one of the actuators. Therefore, a movement of the rod is initiated by at least one of the two actuators that interact with the actuated member connected to the rod such that an initiated movement of the actuated member simultaneously causes the rod to move. The movement of the rod causes the at least one stop washer and the piston to move as well since they are connected with the rod.

In an embodiment, a first stop washer and a second stop washer are provided, wherein the first stop washer contacts the first actuator in the first end position and the second stop washer contacts the second actuator in the second end position. The actuators and the at least one stop washer together define the respective end positions of the rod.

In case only a single stop washer is provided, the single stop washer may move between the actuators such that the single stop washer contacts the first actuator in the first end position and the second actuator in the second end position. For instance, the single stop washer may be established by the actuated member simultaneously, e.g. by a coating of the actuated member.

In an embodiment, the at least one actuator is fixedly located. Thus, the at least one actuator is not moved as the rod moves relatively to the at least one actuator and, therefore, the at least one stop washer and the piston also move relatively to the fixedly located actuator.

A further aspect provides, for example, that the at least one actuator and the at least one stop washer are encompassed by a housing while the rod extends through the housing. The cavity is situated separately with respect to the housing. Thus, the at least one stop washer and the fluid damping mechanism are separately formed and encompassed differently, namely by the housing that encompasses the at least one actuator and the stop washer as well as the separately formed case that delimits the cavity in which the piston is movably located. In this embodiment, the rod extends through both the housing and the case.

According to a further aspect, one end of the rod, for example, is attached to an insulator that is connected to a contact pad, for example a high voltage contact pad. The contact pad is used for electrically connecting at least two contacts associated with coils used for tuning the frequency. The insulator ensures that a distance is provided between the rod and the contact pad such that an arc between the rod and the contact pad is avoided when contacting the contacts.

For instance, the insulator is a plastic rod. The plastic rod can be connected to the rod, for example an end of the rod, which is made of a metal. Due to the plastic rod, insulating properties are obtained.

In an embodiment, the antenna tuning device may comprise at least two contacts that are electrically connected with each other in the first end position by the contact pad. Hence, the at least one actuator moves the rod towards the first end position in which the contact pad gets in contact with both contacts, thereby bridging both contacts in order to provide the electrical connection.

In an embodiment, the at least one stop washer may be made of a plastic material. Therefore, noises can be reduced when the at least one stop washer is contacted in the respective end position. Even though the stop washer is made of a plastic material, the antenna tuning device can be used at low temperature since the at least one stop washer is not subjected to high impacts due to the fluid damping mechanism established by the cavity and the piston that is movably located within the cavity.

In an embodiment, the rod and/or the piston may be made of metal. Thus, the rod is warp resistant.

In general, the fluid dampening mechanism is provided in addition to the at least one stop washer that establishes a mechanical end stop. The piston interacts in both directions of movement with the fluid in the (respective) cavity shortly before the end of the stroke of the rod, e.g. shortly before reaching the respective end position(s).

Due to the high speed, the piston compresses the fluid located within the cavity during the movement, thereby increasing the pressure and generating a braking force via the piston surface. This avoids a hard impact at the end from the stroke, namely the respective end position, while braking the rod gently.

The gap between the piston and the case, which defines the fluid passage, and/or the fluid passage defined by the at least one opening within the piston ensure(s) that the fluid can still escape in a defined manner such that the respective end position is reached and still defined by the at least one stop washer.

Generally, a depression or a channel may be provided on a side surface of the case and/or the piston, along which the fluid may escape when it gets compressed by the movement of the piston.

As a result, the at least one stop washer no longer has to endure the high forces caused by a hard impact at the end of the stroke. Actually, the movement is cushioned softly on the last end by the fluid dampening mechanism.

Consequently, the at least one stop washer can be made of a plastic material such that unnecessary switching noise is avoided. In an embodiment, the at least one stop washer experiences much smaller impact forces and can bear the (reduced) loads even at low temperatures.

The switching times are only slightly prolonged due to the additional fluid dampening mechanism.

In an embodiment, the case(s) encompassing the cavity may comprise at least one control opening via which a negative pressure (“suction”) or a positive pressure is applied on the piston to support movement, for example at the beginning of a movement. The respective control opening may be located in a face side of the case(s) encompassing the cavity, namely a side being perpendicular to a movement direction of the piston.

In an embodiment, a closing member may be provided that may close the at least one control opening in order to ensure sufficient compression of the fluid during a braking of the piston.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows an overview of an antenna tuning device in a first end position according to an embodiment of the disclosure,

FIG. 2 schematically shows the antenna tuning device according of FIG. 1 in a second end position, and

FIG. 3 schematically shows an overview of an antenna tuning device according to another embodiment of the disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

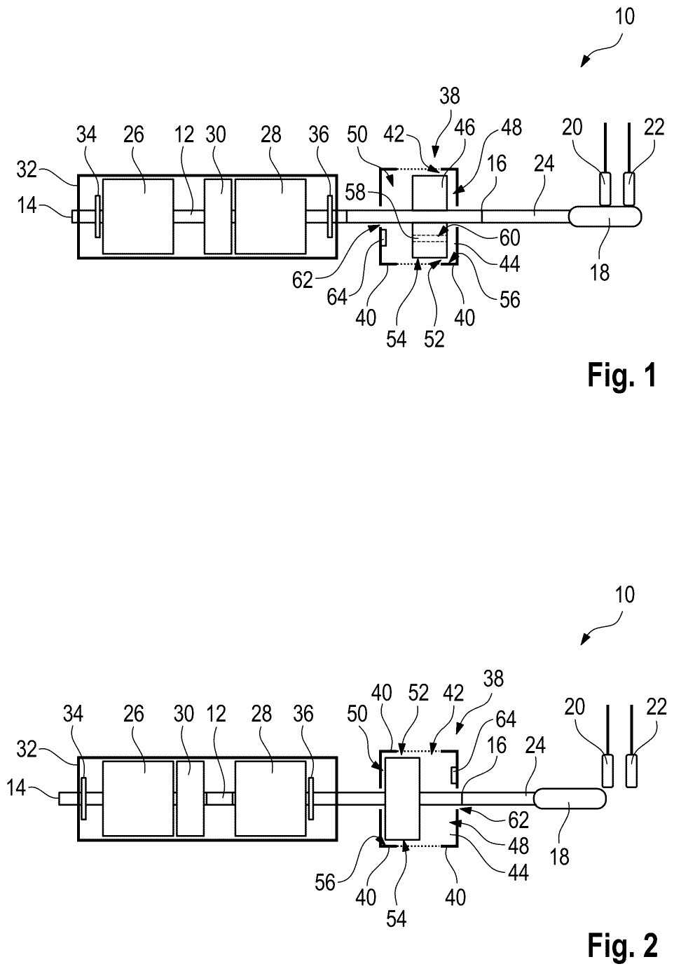

In FIGS. 1 and 2, an antenna tuning device 10 for tuning a frequency is shown according to an embodiment of the disclosure. The antenna tuning device 10 comprises a movable rod 12 that has a first end 14 as well as a second end 16 to which a contact pad 18 is connected.

The contact pad 18 is used to electrically connect two contacts 20, 22 associated with different coils. Generally, the contacts 20, 22 are electrically connected with each other in an iterative manner in order to find a suitable combination of coils. For this purpose, the contact pad 18 is moved forward and backward via the rod 12, thereby ensuring frequent and fast switching is performed until the optimized combination of coils is found that is to be used for the respective frequency.

Since the switching is done when high voltages are applied, large air gaps and switching distances to be bridged are required in order to avoid sparkover. Accordingly, the contact pad 18 is connected to the rod 12 via an insulator 24 that is (directly) connected with the second end 16 of the rod 12. The insulator 24 may be established by a rod made of plastic material.

The movable rod 12 is actuated by at least one actuator 26. In the shown embodiment, two actuators 26, 28 are provided. In an embodiment, the actuators 26, 28 are established by solenoids that are energized in order to generate a magnetic field that interacts with an actuated member 30 in order to exert a magnetic force on the actuated member 30 that is connected to the movable rod 12 such that the movable rod 12 gets moved accordingly. In an embodiment, the actuators 26, 28 as well as the actuated member 30 are located within a housing 32 through which the rod 12 extends.

In order to ensure defined end positions of the rod 12, for example defined end positions of the contact pad 18 connected with the rod 12, the antenna tuning device 10 also comprises at least one stop washer 34 that gets contacted in a respective end position of the rod 12. In the shown embodiment, a first stop washer 34 as well as a second stop washer 36 are provided that are contacted in a first end position and a second end position, respectively. The first end position is shown in FIG. 1, whereas the second end position is shown in FIG. 2.

In the first end position, the first stop washer 34 contacts the first actuator 26. The second stop washer 36 may contact an inner surface of the housing 32 in the first end position. In the second end position, the second stop washer 36 contacts the second actuator 28. The first stop washer 34 may contact an inner surface of the housing 32 in the second end position.

As shown in FIGS. 1 and 2, the actuators 26, 28, the actuated member 30 as well as the stop washers 34, 36 are located within the housing 32. The first stop washer 34, the second stop washer 36 as well as the actuated member 30 are connected to the rod 12 such that these components are also movably located within the housing 32, whereas the actuators 26, 28 are fixedly located within the housing 32.

In general, the movement of the movable rod 12 is restricted by the stop washer 34, 36 and the actuators 26, 28, as the first stop washer 34 contacts the first actuator 26 in the first end position shown in FIG. 1, whereas the second stop washer 36 contacts the second actuator 28 in the second end position shown in FIG. 2.

The actuated member 30 is moved between the actuators 26, 28 accordingly during the switching operation. However, the actuated member 30 does not necessarily come in contact with the actuators 26, 28 in the respective end positions, but it might additionally contact the respective actuators 26, 28, namely the second actuator 28 in the first end position and the first actuator 26 in the second end position.

In general, the stop washers 34, 36 are used to provide the defined end positions of the rod 12 and, therefore, defined end positions of all components connected to the rod 12, for example the contact pad 18. For this purpose and to avoid noises, the stop washers 34, 36 may be made of a plastic material.

In addition to the mechanical end stops provided by the stop washers 34, 36, the antenna tuning device 10 comprises an additional fluid dampening mechanism 38 that is used to dampen the impact on the stop washers 34, 36 during the frequent and fast switching. In other words, the additional fluid dampening mechanism 38 is used to avoid a large impact on the stop washers 34, 36 when the switching is performed.

In an embodiment, the fluid dampening mechanism 38 comprises at least one case 40 defining a cavity 42 that is filled with a fluid 44, for instance air. In the shown embodiment, the cavity 42 is delimited by two separately formed cases 40 that are cup- shaped, wherein these cases 40 are opposite to each other via their open sides. Accordingly, an at least partly opened cavity 42 is provided.

Alternatively, a single (closed) case 40 may be provided that delimits the cavity 42 as indicated by the dotted lines connecting both cup-shaped cases 40. Hence, a closed cavity 42 may be provided.

Irrespective of the shape of the case 40, a piston 46 is movably located within the cavity 42, which is connected to the rod 12. Hence, the piston 46 moves together with the rod 12 when the actuators 26, 28 cause a movement of the rod 12, e.g. by interacting with the actuated member 30.

Accordingly, the fluid dampening mechanism 38 is established by the cavity 42 and the fluid 44 located within the cavity 42, as the movement of the rod 12 is dampened due to the piston 46 compressing the fluid 44 within the cavity 42 before the rod 12 reaches a respective end position.

As shown in the FIGURES, the piston 46 divides a space of the cavity 42 into two parts 48, 50 wherein the size of the parts 48, 50 differs depending on the movement of the rod 12 and, thus, the piston 46 connected thereto.

In the shown embodiment, the at least one case 40 delimiting the cavity 42, e.g. a metal case, is bigger than the piston 46 such that a gap 52 is provided between an outer surface 54 of the piston 46 and an inner surface 56 of the case 40. Thus, the fluid 44 can flow along the gap 52 once the fluid 44 gets compressed by the movement of the piston 46.

Alternatively or additionally, the piston 46 may comprise at least one opening 58 (indicated by dotted lines in FIG. 1) that provides a fluid passage 60 between both parts 48, 50. The size of the at least one opening 58 may be adaptable such that the amount of fluid 44 that can pass through the fluid passage 60 can be set accordingly.

In an embodiment, a depression or a channel may be provided on a side surface of the case 40 and/or the piston 46, along which the fluid 44 may escape when it gets compressed by the movement of the piston 46.

Additionally, the case(s) 40 encompassing the cavity 42 may comprise at least one control opening 62 via which a negative pressure (“suction”) or a positive pressure can be applied on the piston 46 to support movement, for example at the beginning of a movement. The respective control opening 62 may be located in a face side of the case(s) 40 delimiting the cavity 42, namely a side being perpendicular to a movement direction of the piston 46 and/or the rod 12.

In an embodiment, an optional closing member 64 like a foil or similar may be provided that may close the at least one control opening 62 in order to ensure sufficient compression of the fluid 44 during a braking of the piston 46.

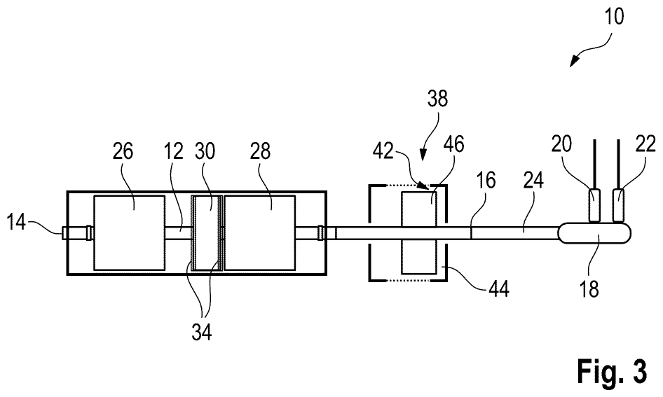

In FIG. 3, an alternative embodiment of the antenna tuning device 10 is shown. This embodiment differs from the embodiment of FIGS. 1 and 2 in that only a single stop washer 34 is provided. In an embodiment, the actuated member 30 itself is the stop washer 34 simultaneously, as it is coated by a plastic material. Therefore, the actuated member 30 is actuated by the actuators 26, 28 such that it comes in contact with them in the respective end positions. The remaining components and their functionality remain the same.

Accordingly, the fluid dampening mechanism 38 ensures that the piston 46 movably located in the cavity 42 filled with the fluid 44 compresses the fluid 44 inside the cavity 42 before the rod 12 reaches a respective end position. Therefore, the movement of the rod 12 is dampened prior to reaching the respective end position such that high impacts on the stop washer(s) 34, 36 can be avoided. Therefore, it is possible to manufacture the stop washer(s) 34, 36 by a material allowing for a defined end position, but reduced noise generation, e.g. a plastic material.

In the foregoing description, specific details are set forth to provide a thorough understanding of representative embodiments of the present disclosure. It will be apparent to one skilled in the art, however, that the embodiments disclosed herein may be practiced without embodying all of the specific details.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. An antenna tuning device for tuning a frequency, wherein the antenna tuning device comprises at least one actuator and a movable rod, wherein at least one stop washer and a piston are connected to the rod, wherein the rod is moveable between a first end position and a second end position, wherein the piston is located in a cavity filled with a fluid such that a movement of the piston compresses the fluid inside the cavity, thereby dampening the movement of the rod prior to reaching the respective end position.

2. The antenna tuning device according to claim 1, wherein the cavity is closed.

3. The antenna tuning device according to claim 1, wherein the cavity is at least partly opened.

4. The antenna tuning device according to claim 1, wherein the piston divides a space of the cavity into two parts.

5. The antenna tuning device according to claim 4, wherein the piston comprises at least one opening that provides a fluid passage between both parts.

6. The antenna tuning device according to claim 5, wherein the size of the at least one opening is adaptable.

7. The antenna tuning device according to claim 1, wherein the dimension of the cavity is bigger than the dimension of the piston such that a gap is provided.

8. The antenna tuning device according to claim 1, wherein the at least one actuator is a solenoid.

9. The antenna tuning device according to claim 1, wherein a first actuator and a second actuator are provided, wherein an actuated member is located between the first actuator and the second actuator, and wherein the actuated member is connected to the rod.

10. The antenna tuning device according to claim 9, wherein a first stop washer and a second stop washer are provided, wherein the first stop washer contacts the first actuator in the first end position and wherein the second stop washer contacts the second actuator in the second end position.

11. The antenna tuning device according to claim 1, wherein the at least one actuator is fixedly located.

12. The antenna tuning device according to claim 1, wherein the at least one actuator and the at least one stop washer are encompassed by a housing while the rod extends through the housing, and wherein the cavity is situated separately with respect to the housing.

13. The antenna tuning device according to claim 1, wherein one end of the rod is attached to an insulator that is connected to a contact pad.

14. The antenna tuning device according to claim 13, wherein the insulator is a plastic rod.

15. The antenna tuning device according to claim 13, wherein at least two contacts are provided that are electrically connected with each other in the first end position by the contact pad.

16. The antenna tuning device according to claim 1, wherein the at least one stop washer is made of a plastic material.
